(19) United States
(12) Patent Application Publication
(10) Pub. No.: US 2019/0291583 A1
(43) Pub. Date: Sep. 26, 2019

(54) RAILCAR BOGIE

(71) Applicant: KAWASAKI JUKOGYO KABUSHIKI KAISHA, Kobe-shi, Hyogo (JP)

(72) Inventors: Yoshi SATO, Sanda-shi (JP); Takehiro NISHIMURA, Kobe-shi (JP); Keiichiro KAMURA, Kobe-shi (JP); Koichi MURATA, Kobe-shi (JP); Francois Olivier UCHIDA, Kobe-shi (JP)

(73) Assignee: KAWASAKI JUKOGYO KABUSHIKI KAISHA, Kobe-shi, Hyogo (JP)

(21) Appl. No.: 16/463,894

(22) PCT Filed: Mar. 14, 2017
(86) PCT No.: PCT/JP2017/010190

§ 371 Date: May 24, 2019

(30) Foreign Application Priority Data
Nov. 24, 2016 (JP) 2016-227810

(51) Int. Cl. B60L 5/39; B61F 5/30; B61F 5/44; B61F 5/52; F16F 1/38

(52) U.S. Cl. CPC B60L 5/39; B61F 5/30; F16F 1/38; B61F 5/52; B61F 5/44

(57) ABSTRACT

A railcar bogie includes: a bogie frame; a first axle box accommodating a first bearing supporting a first axle; a second axle box accommodating a second bearing supporting a second axle; a supporting device connected to the bogie frame and also connected to the first axle box or a member provided at the first axle box, unsprung vibration being transferred to the first axle box; and a third-rail current collector attached to the supporting device.

### TECHNICAL FIELD

The present invention relates to a railcar bogie including a third-rail current collector.

### BACKGROUND ART

There are a plurality of systems as means by which a railcar collects current from a ground facility. According to a third rail system, a third rail (current supply rail) is laid in parallel with a pair of traveling rails, and current is collected when a current collecting shoe of a current collector provided at a bogie contacts and slides on the third rail.

According to the bogie of PTL 1, a current collecting beam extends between a pair of front and rear axle boxes, and a current collector is attached to the current collecting beam. According to the bogie of PTL 2, links including elastic bushings are provided between the current collecting beam and the front axle box and between the current collecting beam and the rear axle box, and the current collector is attached to the current collecting beam. According to the bogie of PTL 3, the current collector is attached to a bogie frame. According to the bogie of PTL 4, the current collector is attached to only one of the front and rear axle boxes.

### CITATION LIST

### Patent Literature

PTL 1: Japanese Laid-Open Utility Model Application Publication No. 50-133607
PTL 2: U.S. Pat. No. 6,079,335
PTL 3: Japanese Laid-Open Utility Model Application Publication No. 50-133608
PTL 4: Japanese Laid-Open Patent Application Publication No. 2012-130142

### SUMMARY OF INVENTION

### Technical Problem

According to the bogies of PTLs 1 and 2, vibration of the pair of axle boxes as unsprung mass is transferred to the current collecting beam, and therefore, vibration of the current collector increases. Further, when a steering mechanism is provided at the bogie of PTL 1, and the front and rear axle boxes are displaced relative to each other by steering so as to approach each other or separate from each other, the current collecting beam cannot follow such relative displacement. According to the bogie of PTL 2, the current collecting beam can follow the relative displacement between the front and rear axle boxes by the links including the elastic bushings. However, since the relative displacement is large during steering, an angular displacement of each elastic bushing increases, and this shortens the life of the elastic bushing.

According to the bogie of PTL 3, even when the steering mechanism is provided at the bogie, the current collector is attached to the bogie frame, so that the steering operation does not influence the current collector. However, when axle springs expand and contract by traveling vibration and vehicle occupancy fluctuation, the bogie frame is vertically displaced, and this causes vertical displacement of the current collector. Therefore, in order to prevent the vertical displacement of the current collector from exceeding a permissible range, spring constants of the axle springs need to be made large, and this deteriorates ride quality of passengers.

According to the bogie of PTL 4, since the current collector is attached to only one of the front and rear axle boxes, the current collector is not influenced by steering. However, as unsprung vibration increases by an increase in unsprung weight, the unsprung vibration concentrates on the current collector. Therefore, rubber supporting the current collector needs to be made soft, and this shortens the life of the rubber.

As above, regardless of the presence or absence of the steering mechanism at the bogie, it is currently difficult to realize both a reduction in vibration of a third-rail current collector and prevention of deterioration of ride quality of passengers.

An object of the present invention is to realize both a reduction in vibration of a third-rail current collector and prevention of deterioration of ride quality of passengers.

### Solution to Problem

A railcar bogie according to one aspect of the present invention includes: a bogie frame; a first axle box accommodating a first bearing supporting a first axle; a second axle box accommodating a second bearing supporting a second axle; a supporting device connected to the bogie frame and also connected to the first axle box or a member provided at the first axle box, unsprung vibration being transferred to the first axle box; and a third-rail current collector attached to the supporting device.

According to the above configuration, since the supporting device is connected to the first axle box (or the member provided at the first axle box) and the bogie frame, vibration of the second axle box as unsprung mass is prevented from being directly transferred to the supporting device. In addition, since the supporting device is connected to the bogie frame as sprung mass, vibration of the supporting device caused by vibration of the first axle box is suppressed. Therefore, vibration transferred to the current collector can be made smaller than a case where the supporting device is connected to the first axle box and the second axle box.

Further, since the supporting device is connected to not only the bogie frame but also the first axle box, vertical displacement of the current collector when the bogie frame is vertically displaced by the expansion and contraction of springs is suppressed. Therefore, the necessity of increasing the spring constants of the springs for preventing the vertical displacement of the current collector relative to the third rail from exceeding a permissible amount can be reduced, and the ride quality of passengers can be prevented from deteriorating.

### Advantageous Effects of Invention

According to the present invention, a reduction in vibration of a third-rail current collector and prevention of deterioration of ride quality of passengers can be realized at the same time.

### BRIEF DESCRIPTION OF DRAWINGS

FIG. 1 is a side view of a railcar bogie according to Embodiment 1.

FIG. 2A is a sectional view showing an axle box bracket of FIG. 1 and its vicinity when viewed from a car width direction. FIG. 2B is a sectional view taken along line IIb-IIb of FIG. 2A.

FIG. 3A is a sectional view showing a bogie frame bracket of FIG. 1 and its vicinity when viewed from the car width direction. FIG. 3B is a sectional view taken along line IIIb-IIIb of FIG. 3A.

FIG. 4A is a schematic diagram showing a supporting device located at an inner rail side during steering. FIG. 4B is a schematic diagram showing a supporting device located at an outer rail side during steering.

FIG. 5 is a diagram showing the railcar bogie according to Embodiment 2 and corresponding to FIG. 2A.

FIG. 6A is a sectional view showing the axle box bracket of the railcar bogie according to Embodiment 3 and its vicinity when viewed from the car width direction. FIG. 6B is a sectional view taken along line VIb-VIb of FIG. 6A.

FIG. 7 is a sectional view showing the bogie frame bracket of the bogie of FIG. 6 and its vicinity when viewed from the car width direction.

FIG. 8 is a side view of the railcar bogie according to Embodiment 4.

### DESCRIPTION OF EMBODIMENTS

Hereinafter, embodiments will be explained with reference to the drawings. In the following explanation, a direction in which a railcar travels and a carbody extends is defined as a car longitudinal direction, and a crosswise direction perpendicular to the car longitudinal direction is defined as a car width direction. The car longitudinal direction may be referred to as a front-rear direction, and the car width direction may be referred to as a left-right direction.

### Embodiment 1

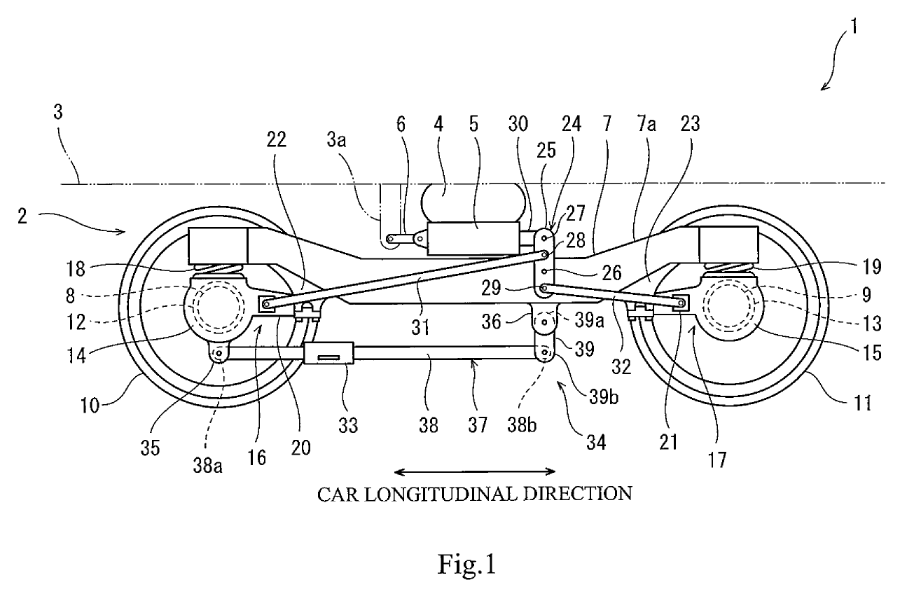

FIG. 1 is a side view of a bogie 2 of a railcar 1 according to Embodiment 1. As shown in FIG. 1, the bogie 2 is a steering bogie. The bogie 2 supports a carbody 3 of the railcar 1 from below. The bogie 2 includes a bolster 5 supporting the carbody 3 through an air spring 4. The bolster 5 is connected to a bracket 3a of the carbody 3 by a bolster anchor 6. The bolster 5 is connected to a bogie frame 7 through a turn guide mechanism (for example, a center pin and a center plate) arranged at a bogie center. To be specific, the bogie frame 7 supports the bolster 5 from below so as to be turnable relative to the carbody 3 and the bolster 5 in a yawing direction.

The bogie frame 7 includes a cross beam (not shown) and a pair of side sills 7a. The cross beam extends in the car width direction under the bolster 5. The side sills 7a are connected to both respective car width direction end portions of the cross beam and extend in the car longitudinal direction. A first axle 8 extending in the car width direction is arranged at one side of the bogie frame 7 in the car longitudinal direction, and a second axle 9 extending in the car width direction is arranged at the other side of the bogie frame 7 in the car longitudinal direction. First wheels 10 are provided at both respective car width direction side portions of the first axle 8, and second wheels 11 are provided at both respective car width direction side portions of the second axle 9. First bearings 12 are provided at both respective car width direction side end portions of the first axle 8 so as to rotatably support the first axle 8, and second bearings 13 are provided at both respective car width direction side end portions of the second axle 9 so as to rotatably support the second axle 9. The first bearings 12 are accommodated in respective first axle boxes 14, and the second bearings 13 are accommodated in respective second axle boxes 15.

The first axle box 14 and the second axle box 15 are arranged away from each other in the car longitudinal direction. The first axle box 14 is elastically coupled to the bogie frame 7 through a first axle box suspension 16, and the second axle box 15 is elastically coupled to the bogie frame 7 through a second axle box suspension 17. The first axle box suspension 16 includes a first axle spring 18 (coil spring) and a first axle beam 20. The first axle spring 18 is interposed between the side sill 7a and the first axle box 14. The first axle beam 20 projects from the first axle box 14 in the car longitudinal direction toward a bogie middle side in a side view and is coupled to the side sill 7a. The second axle box suspension 17 includes a second axle spring 19 (coil spring) and a second axle beam 21. The second axle spring 19 is interposed between the side sill 7a and the second axle box 15. The second axle beam 21 projects from the second axle box 15 in the car longitudinal direction toward the bogie middle side in a side view and is coupled to the side sill 7a. The bogie frame 7 includes a first receiving seat 22 and a second receiving seat 23. The first receiving seat 22 projects from the side sill 7a toward the first axle beam 20, and the second receiving seat 23 projects from the side sill 7a toward the second axle beam 21. A tip end portion of the first axle beam 20 is elastically coupled to the first receiving seat 22 through an elastic bushing (not shown), and a tip end portion of the second axle beam 21 is elastically coupled to the second receiving seat 23 through an elastic bushing (not shown). To be specific, the first axle box suspension 16 and the second axle box suspension 17 are so-called axle beam type suspensions.

The bogie 2 includes a steering mechanism 24 configured to steer the first axle 8 and the second axle 9 by tilting the first axle 8 and the second axle 9 relative to the bogie frame 7 in the yawing direction. The steering mechanism 24 includes a steering lever 25 arranged outside the bogie frame 7 in the car width direction. The steering lever 25 includes a fulcrum 26, a force point 27, a first action point 28, and a second action point 29. The first action point 28 is arranged at one side of the fulcrum 26, and the second action point 29 is arranged at the other side of the fulcrum 26. The steering lever 25 is supported by the bogie frame 7 so as to be turnable about an axis extending in the car width direction at the fulcrum 26. The steering lever 25 is coupled to the bolster 5 at the force point 27 through a coupling link 30.

The steering lever 25 is coupled to the first axle box 14 at the first action point 28 through a first steering link 31 (and the first axle beam 20) and also coupled to the second axle box 15 at the second action point 29 through a second steering link 32 (and the second axle beam 21). When the bogie 2 passes through a curved line, the steering mechanism 24 operates in conjunction with the turning of the bogie frame 7 relative to the carbody 3 and the bolster 5 about a vertical axis. With this, the steering lever 25 turns about the fulcrum 26 in a vertical flat plane, and this displaces the first axle box 14 and the second axle box 15 relative to the bogie frame 7 in the car longitudinal direction. Thus, the first wheels 10 and the second wheels 11 are steered along the curved line.

The bogie 2 includes a supporting device 34 to which a third-rail current collector 33 is attached. The supporting device 34 is connected to the bogie frame 7 (i.e., a sprung member) and the first axle box 14 (i.e., an unsprung member) but is not connected to the second axle box 15 (i.e., an unsprung member). To be specific, the movement of the first axle box 14, such as unsprung vibration, is transferred to the supporting device 34, but the movement of the second axle box 15 is not transferred to the supporting device 34. The supporting device 34 includes an axle box bracket 35, a bogie frame bracket 36, and a current collection link mechanism 37. The axle box bracket 35 is provided at the first axle box 14, and the bogie frame bracket 36 is provided at the bogie frame 7. The current collection link mechanism 37 is coupled to the axle box bracket 35 and the bogie frame bracket 36.

The axle box bracket 35 projects downward from a lower end portion of the first axle box 14. The axle box bracket 35 may be fixed to the first axle box 14 by a fastening member, welding, or the like, or may be formed continuously with the first axle box 14. The bogie frame bracket 36 projects downward from the bogie frame 7 (for example, the side sill 7a). In the present embodiment, the bogie frame bracket 36 is arranged closer to the second axle box 15 than the center of the bogie frame 7.

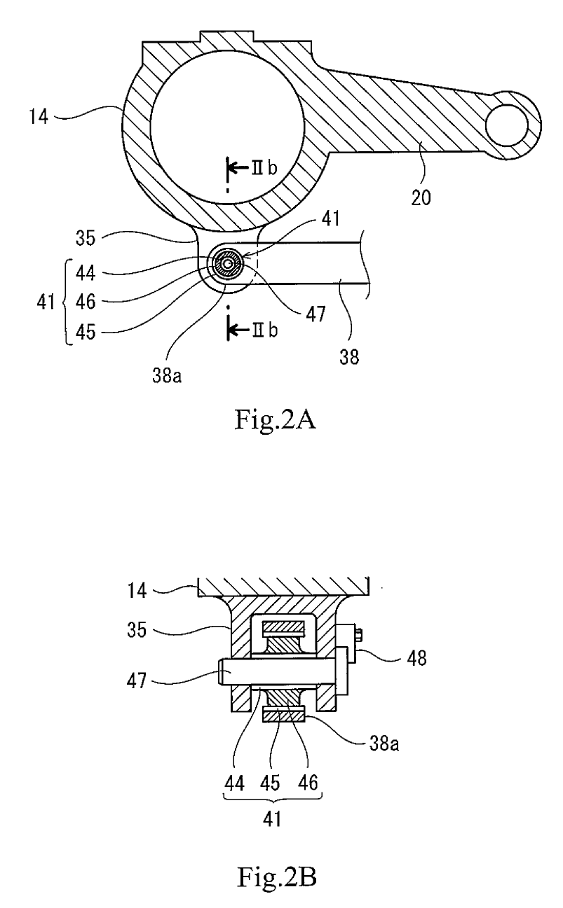

The current collection link mechanism 37 includes a current collecting beam 38, an arm 39, and below-described first to third elastic bushings 41 to 43 (see FIGS. 2A and 2B). The current collecting beam 38 extends in the car longitudinal direction, and the current collector 33 is attached to the current collecting beam 38. In the present embodiment, the current collector 33 is attached to a position displaced from the center of the current collecting beam 38 in the longitudinal direction (toward the first axle box 14, for example). A first end portion 38a of the current collecting beam 38 is turnably coupled to the axle box bracket 35. The arm 39 extends in the upper-lower direction. A first end portion 39a (upper end portion) of the arm 39 is turnably coupled to the bogie frame bracket 36. A second end portion 38b of the current collecting beam 38 is turnably coupled to a second end portion 39b (lower end portion) of the arm 39.

FIG. 2A is a sectional view showing the axle box bracket 35 of FIG. 1 and its vicinity when viewed from the car width direction. FIG. 2B is a sectional view taken along line IIb-IIb of FIG. 2A. As shown in FIGS. 2A and 2B, a first elastic bushing 41 is interposed between the first end portion 38a of the current collecting beam 38 and the axle box bracket 35. The axle box bracket 35 includes a pair of walls opposed to each other in the car width direction, and the first elastic bushing 41 is arranged between the walls. The first elastic bushing 41 includes an inner tube 44, an outer tube 45, and a first elastic body 46 (for example, rubber) interposed between the inner tube 44 and the outer tube 45. The first elastic bushing 41 is arranged such that an axis thereof is directed in the car width direction. A pin 47 including an axis directed in the car width direction is attached to the axle box bracket 35, and the inner tube 44 is externally fitted to the pin 47. The first end portion 38a of the current collecting beam 38 has a cylindrical shape and is externally fitted to the outer tube 45. The pin 47 is retained by a pin retaining member 48 detachably fixed to the axle box bracket 35.

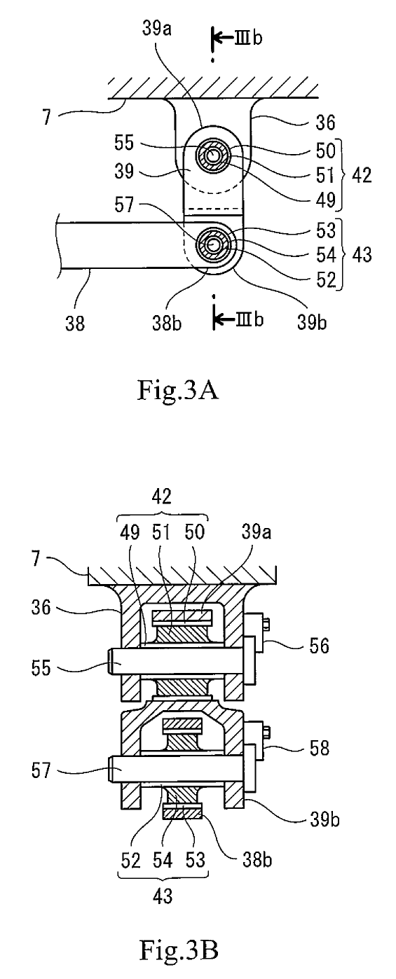

FIG. 3A is a sectional view showing the bogie frame bracket 36 of FIG. 1 and its vicinity when viewed from the car width direction. FIG. 3B is a sectional view taken along line of FIG. 3A. As shown in FIGS. 3A and 3B, a second elastic bushing 42 is interposed between the first end portion 39a of the arm 39 and the bogie frame bracket 36. A third elastic bushing 43 is interposed between the second end portion 38b of the current collecting beam 38 and the second end portion 39b of the arm 39. Each of the second elastic bushing 42 and the third elastic bushing 43 is the same in structure as the first elastic bushing 41. To be specific, the second elastic bushing 42 includes an inner tube 49, an outer tube 50, and a second elastic body 51 (for example, rubber), and the third elastic bushing 43 includes an inner tube 52, an outer tube 53, and a third elastic body 54 (for example, rubber). Each of the second elastic bushing 42 and the third elastic bushing 43 is arranged such that an axis thereof is directed in the car width direction.

The bogie frame bracket 36 includes a pair of walls opposed to each other in the car width direction, and the second elastic bushing 42 is arranged between the walls. A pin 55 including an axis directed in the car width direction is attached to the bogie frame bracket 36, and the inner tube 49 of the second elastic bushing 42 is externally fitted to the pin 55. The first end portion 39a of the arm 39 has a cylindrical shape and is externally fitted to the outer tube 50 of the second elastic bushing 42. The pin 55 is retained by a pin retaining member 56 detachably fixed to the bogie frame bracket 36.

The second end portion 39b of the arm 39 includes a pair of walls opposed to each other in the car width direction, and the third elastic bushing 43 is arranged between the walls. A pin 57 including an axis directed in the car width direction is attached to the second end portion 39b of the arm 39, and the inner tube 52 of the third elastic bushing 43 is externally fitted to the pin 57. The second end portion 38b of the current collecting beam 38 has a cylindrical shape and is externally fitted to the outer tube 53 of the third elastic bushing 43. The pin 57 is retained by a pin retaining member 58 detachably fixed to the arm 39.

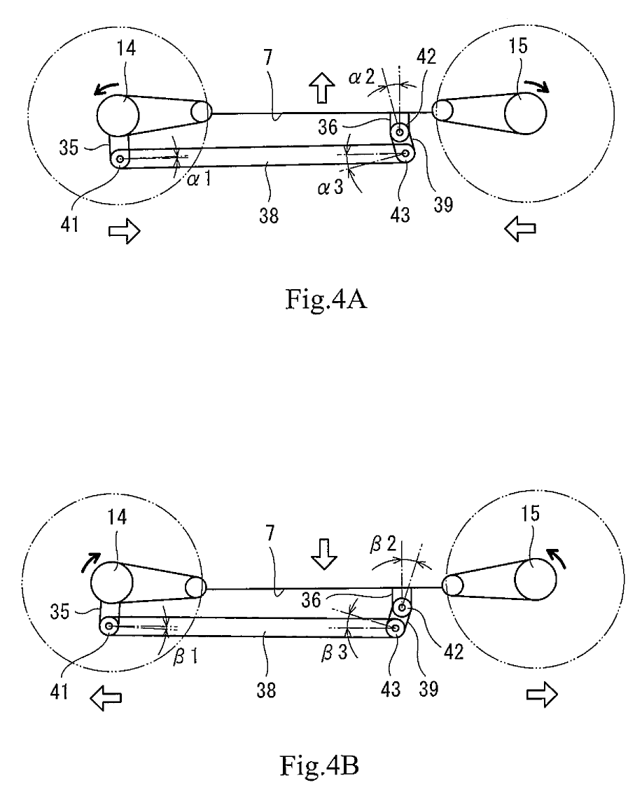

FIG. 4A is a schematic diagram showing the supporting device 34 when the axle spring expands at the inner rail side during steering. FIG. 4B is a schematic diagram showing the supporting device 34 when the axle spring contracts at the outer rail side during steering. As shown in FIG. 4A, when the car passes through a curved line, the first axle box 14 and the second axle box 15 at the inner rail side are displaced by steering so as to approach each other, and a portion of the bogie frame 7 which portion is located at the inner rail side is displaced upward by a load movement caused by centrifugal force of the carbody. As a result, at the inner rail side, an operation angle α1 of the first elastic bushing 41 becomes smaller than each of an operation angle α2 of the second elastic bushing 42 and an operation angle α3 of the third elastic bushing 43.

As shown in FIG. 4B, when the car passes through a curved line, the first axle box 14 and the second axle box 15 at the outer rail side are displaced by steering so as to separate from each other, and a portion of the bogie frame 7 which portion is located at the outer rail side is displaced downward by the load movement caused due to the centrifugal force of the carbody. At the outer rail side, an operation angle β1 of the first elastic bushing 41 becomes smaller than each of an operation angle β2 of the second elastic bushing 42 and an operation angle β3 of the third elastic bushing 43.

According to the above-explained configuration, since the supporting device 34 is connected to the first axle box 14 and the bogie frame 7, vibration of the second axle box 15 as unsprung mass is prevented from being directly transferred to the supporting device 34. In addition, since the supporting device 34 is connected to the bogie frame 7 as sprung mass, vibration of the supporting device 34 caused by vibration of the first axle box 14 is suppressed. Therefore, vibration transferred to the current collector 33 can be made smaller than a case where the supporting device 34 is connected to the first axle box 14 and the second axle box 15.

Further, since the supporting device 34 is connected to not only the bogie frame 7 but also the first axle box 14, vertical displacement of the current collector 33 when the bogie frame 7 is vertically displaced by the expansion and contraction of the first axle spring 18 and the second axle spring 19 is suppressed. Therefore, the necessity of increasing the spring constants of the first axle spring 18 and the second axle spring 19 for preventing the vertical displacement of the current collector 33 relative to the third rail from exceeding a permissible amount can be reduced, and the ride quality of passengers can be prevented from deteriorating.

The supporting device 34 includes the current collection link mechanism 37. Therefore, even when the relative displacement occurs between the first axle box 14 and the bogie frame 7, the supporting device 34 can smoothly follow the relative displacement by the operation of the current collection link mechanism 37. In addition, the displacement of the second axle box 15 does not influence the supporting device 34. Therefore, increases in deformation amounts of the first to third elastic bodies 46, 51, and 54 of the current collection link mechanism 37 when the large relative displacement occurs between the first axle box 14 and the second axle box 15 can be prevented. With this, the lives of the first to third elastic bodies 46, 51, and 54 can be lengthened.

The current collecting beam 38 is turnably coupled to the axle box bracket 35, and the arm 39 is turnably coupled to the bogie frame bracket 36. The number of turning points of the current collection link mechanism 37 is only three. Therefore, the current collection link mechanism 37 is simplified, and an increase in weight of the bogie can be suppressed. Further, since the supporting device 34 is connected to the first axle box 14 and the bogie frame 7 but is not connected to the second axle box 15, the relative displacement between the first axle box 14 and the second axle box 15 by steering is prevented from influencing the supporting device 34. Therefore, the load applied to the supporting device 34 during steering is reduced, and this can simplify the supporting device 34 and lengthen the life of the supporting device 34.

During traveling, vibration of each of the axle boxes 14 and 15 as unsprung mass becomes larger than vibration of the bogie frame 7 as sprung mass. Further, when the distance between the bogie frame 7 and the axle box 14, 15 changes by the vertical movement of the bogie frame 7 caused by the expansion and contraction of the axle springs 18 and 19, the arm 39 turns more largely than the current collecting beam 38. However, the current collecting beam 38 which does not turn largely is coupled to the axle box bracket 35 which vibrates largely, and the arm 39 which turns largely is coupled to the bogie frame bracket 36 which does not vibrate largely. Therefore, at least one of the vibration and turn of the first elastic body 46 interposed between the current collecting beam 38 and the axle box bracket 35 is prevented from becoming large, and this can prevent the first elastic body 46 from deteriorating quickly. This effect of preventing the deterioration of the first elastic body 46 is significant especially in the steering bogie.

To be specific, as shown in FIGS. 4A and 4B, during steering, at the inner rail side and the outer rail side, the operation angles α1 and β1 of the first elastic bushing 41 become significantly smaller than the operation angles α2 and β2 of the second elastic bushing 42 and the operation angles α3 and β3 of the third elastic bushing 43. Therefore, the operation angle of the first elastic bushing 41 which vibrates most since the first elastic bushing 41 is located closest to the first axle box 14 among the first to third elastic bushings is kept within a small range, and this can lengthen the life of the elastic body 46.

### Embodiment 2

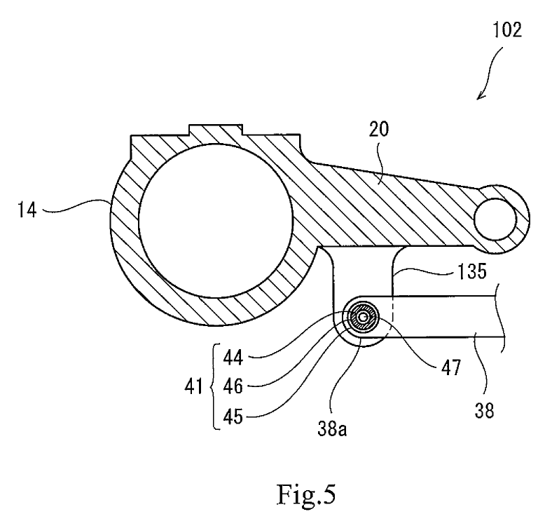

FIG. 5 is a diagram showing a railcar bogie 102 according to Embodiment 2 and corresponding to FIG. 2A. As shown in FIG. 5, in the bogie 102 of Embodiment 2, an axle box bracket 135 is provided at the first axle beam 20 provided integrally with the first axle box 14. To be specific, the axle box bracket 135 is arranged at a bogie center side of the first axle box 14 in the carbody longitudinal direction. A lower end of the first axle beam 20 is located higher than a lower end of the first axle box 14. The first end portion 38a of the current collecting beam 38 is turnably coupled to the axle box bracket 135 through the first elastic bushing 41. With this configuration, in the bogie 102 of Embodiment 2, the current collecting beam 38 can be arranged higher than that of the bogie 2 of Embodiment 1. Therefore, when the car gauge is severe in the vicinity of the current collecting beam 38, the degree of freedom of design can be increased.

Since the other components are the same as those of Embodiment 1, explanations thereof are omitted. Further, a member at which the axle box bracket is provided does not have to be the axle beam. To be specific, the member at which the axle box bracket is provided may be a different member as long as the supporting device to which the current collector 33 is attached is connected to a member, provided integrally with the first axle box 14, to be indirectly connected to the first axle box 14.

### Embodiment 3

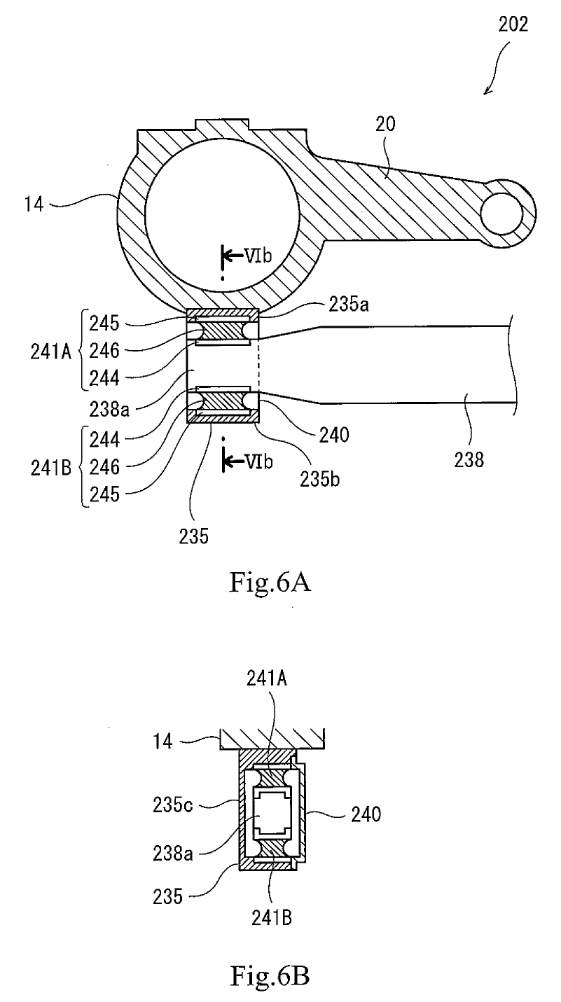

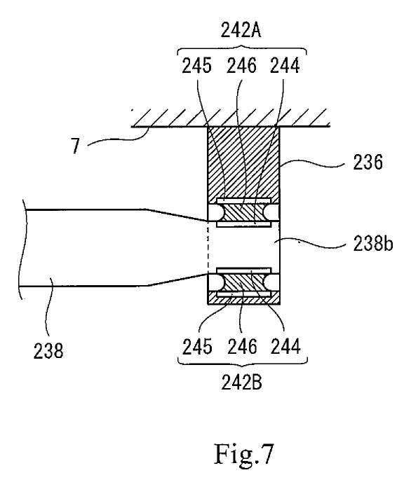

FIG. 6A is a sectional view showing an axle box bracket 235 of a railcar bogie 202 of Embodiment 3 and its vicinity when viewed from the car width direction. FIG. 6B is a sectional view taken along line VIb-VIb of FIG. 6A. FIG. 7 is a sectional view showing a bogie frame bracket 236 of the bogie 202 of FIG. 6 and its vicinity when viewed from the car width direction. The bogie 202 of Embodiment 3 is a non-steering bogie not including a steering mechanism. As shown in FIGS. 6A, 6B, and 7, a supporting device 234 to which a third-rail current collector is attached is connected to the bogie frame 7 and the first axle box 14 but is not connected to the second axle box 15. The supporting device 234 includes the axle box bracket 235, the bogie frame bracket 236, a current collecting beam 238, a pair of first elastic units 241A and 241B, and a pair of second elastic units 242A and 242B.

The axle box bracket 235 is provided at the first axle box 14 and projects downward from the first axle box 14. The bogie frame bracket 236 is provided at the bogie frame 7 and projects downward from the bogie frame 7. The current collecting beam 238 is coupled to the axle box bracket 235 and the bogie frame bracket 236. The first elastic units 241A and 241B are interposed between the axle box bracket 235 and the current collecting beam 238. The second elastic units 242A and 242B are interposed between the bogie frame bracket 236 and the current collecting beam 238.

As shown in FIGS. 6A and 6B, the axle box bracket 235 includes an upper wall portion 235a, a lower wall portion 235b, and a side wall portion 235c coupling the upper wall portion 235a and the lower wall portion 235b. The first elastic unit 241A is interposed between a first end portion 238a of the current collecting beam 238 and the upper wall portion 235a, and the first elastic unit 241B is interposed between the first end portion 238a of the current collecting beam 238 and the lower wall portion 235b. Each of the first elastic units 241A and 241B includes an elastic body 246 (for example, rubber) and a pair of plates 244 and 245 vertically sandwiching the elastic body 246. The first end portion 238a of the current collecting beam 238 and each plate 244 contacting the first end portion 238a are positioned in the car longitudinal direction and the car width direction by a concave-convex fitting structure. A lid 240 is detachably fixed to the axle box bracket 235. The lid 240 covers the first elastic units 241A and 241B from an opposite side of the side wall portion 235c. Each plate 245 contacting the axle box bracket 235 is positioned in the car longitudinal direction and the car width direction by the axle box bracket 235 and the lid 240.

As shown in FIG. 7, the bogie frame bracket 236 is the same in structure as the axle box bracket 235. The second elastic units 242A and 242B are the same in structure as the first elastic units 241A and 241B. To be specific, each of the second elastic units 242A and 242B includes the elastic body 246 (for example, rubber) and the pair of plates 244 and 245 vertically sandwiching the elastic body 246. A second end portion 238b of the current collecting beam 238 and each plate 244 contacting the second end portion 238b are positioned in the car longitudinal direction and the car width direction by a concave-convex fitting structure. Each plate 245 contacting the bogie frame bracket 236 is positioned in the car longitudinal direction and the car width direction by the bogie frame bracket 236 and the lid 240.

Since the other components are the same as those of Embodiment 1, explanations thereof are omitted. Further, instead of arranging the first elastic units 241A and 241B and the second elastic units 242A and 242B at upper and lower sides of the current collecting beam 238, these units may be arranged at left and right sides of the current collecting beam 238 or may be arranged at upper, lower, left, and right sides of the current collecting beam 238.

### Embodiment 4

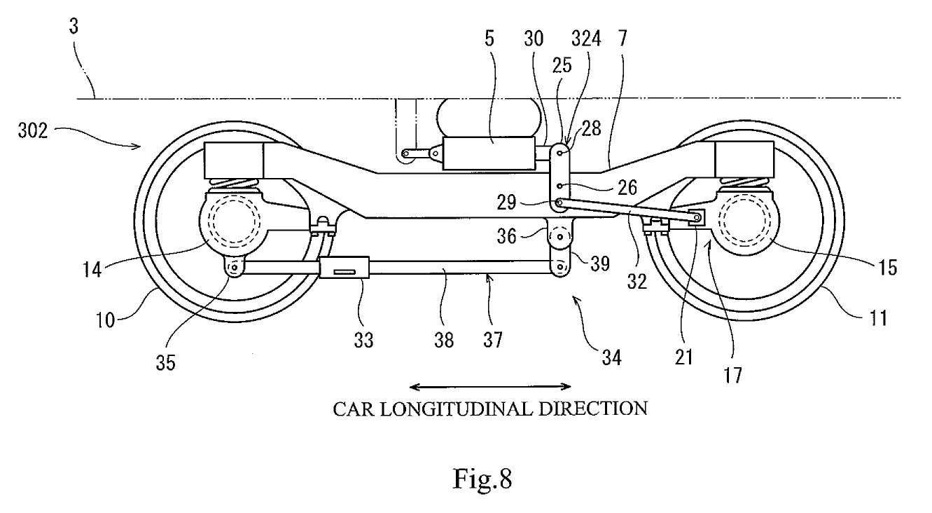

FIG. 8 is a side view of a railcar bogie 302 according to Embodiment 4. As shown in FIG. 8, the bogie 302 of Embodiment 4 is a single axle steering bogie. To be specific, the bogie 302 includes a steering mechanism 324 configured not to steer the first axle box 14 but to steer only the second axle box 15. Specifically, the steering mechanism 324 is the same in configuration as the steering mechanism 24 of Embodiment 1 except that the steering mechanism 324 does not include the first steering link 31. When the bogie 302 passes through a curved line, the steering mechanism 324 operates in conjunction with the turning of the bogie frame 7 relative to the carbody 3 about a vertical axis. With this, the second axle box 15 is displaced relative to the bogie frame 7 in the car longitudinal direction, and only the second wheels 11 are steered along a curved line.

According to this configuration, since the first axle box 14 to which the supporting device 34 is connected is not steered, the influence on the supporting device 34 by the relative displacement between the first axle box 14 and the second axle box 15 due to the steering can be eliminated. Therefore, the smooth steering, the simplification of the supporting device 34, and the increase in the life of the supporting device 34 can be suitably realized at the same time. Since the other components are the same as those of Embodiment 1, explanations thereof are omitted.

The present invention is not limited to the above embodiments, and modifications, additions, and eliminations may be made with respect to the configuration of the present invention. The above embodiments may be combined arbitrarily. For example, some of components in one embodiment may be applied to another embodiment. Some of components in an embodiment may be separated and extracted arbitrarily from the other of the components in the embodiment. The current collection link mechanism 37 may be configured such that: the current collecting beam 38 is turnably coupled to the bogie frame bracket 36; and the arm 39 is turnably coupled to the axle box bracket 35. The elastic body of the supporting device may be arranged only at a route from the first axle box to the current collector or arranged at a route from the bogie frame to the current collector. Or, the elastic body does not have to be provided at the supporting device.

The steering mechanism does not have to be a link type and may be operated by an actuator. The type of the bogie is not especially limited, and the configurations of Embodiments 1 to 4 are applicable to both the steering bogie and the non-steering bogie. The axle box suspension does not have to be the axle beam type suspension and may be the other type suspension. The bogie may be a bolsterless bogie instead of a bogie with a bolster. The bogie may include plate springs instead of the side sills 7a and the coil springs 18 and 19. To be specific, a pair of front and rear axle boxes may support both respective longitudinal direction end portions of each plate spring, and longitudinal direction middle portions of the plate springs may support a cross beam.

### REFERENCE SIGNS LIST

2, 102, 202, 302 bogie
7 bogie frame
8 first axle
9 second axle
12 first bearing
13 second bearing
14 first axle box
15 second axle box
18 first axle spring
19 second axle spring
24, 324 steering mechanism
33 current collector
34, 234 supporting device
35, 135, 235 axle box bracket
36, 236 bogie frame bracket
37 current collection link mechanism
38, 238 current collecting beam
39 arm
46 first elastic body
51 second elastic body
54 third elastic body
246 elastic body

1. A railcar bogie comprising:
a bogie frame;
a first axle box accommodating a first bearing supporting a first axle;
a second axle box accommodating a second bearing supporting a second axle;
a supporting device connected to the bogie frame and also connected to the first axle box or a member provided at the first axle box, unsprung vibration being transferred to the first axle box; and
a third-rail current collector attached to the supporting device.

2. The railcar bogie according to claim 1, wherein:
the supporting device includes at least one elastic body; and
the at least one elastic body is arranged at at least a portion of the supporting device which portion is included in a route from the first axle box to the current collector.

3. The railcar bogie according to claim 2, wherein:
the supporting device includes
an axle box bracket provided at the first axle box or the member provided at the first axle box,
a bogie frame bracket provided at the bogie frame, and
a current collection link mechanism coupled to the axle box bracket and the bogie frame bracket; and
the current collection link mechanism includes
a current collecting beam turnably coupled to one of the axle box bracket and the bogie frame bracket, the current collector being attached to the current collecting beam,
an arm turnably coupled to the current collecting beam and also turnably coupled to the other of the axle box bracket and the bogie frame bracket, and
the at least one elastic body interposed at least one of between the current collecting beam and the one of the axle box bracket and the bogie frame bracket, between the current collecting beam and the arm, and between the arm and the other of the axle box bracket and the bogie frame bracket.

4. The railcar bogie according to claim 3, wherein:
the current collecting beam extends in a car longitudinal direction;
the arm extends in an upper-lower direction;
a first end portion of the current collecting beam is coupled to the axle box bracket;
a first end portion of the arm is coupled to the bogie frame bracket;
a second end portion of the current collecting beam is coupled to a second end portion of the arm; and
the at least one elastic body includes a first elastic body interposed between the current collecting beam and the axle box bracket, a second elastic body interposed between the arm and the bogie frame bracket, and a third elastic body interposed between the current collecting beam and the arm.

5. The railcar bogie according to claim 1, further comprising a steering mechanism configured to steer at least one of the first axle and the second axle.

6. The railcar bogie according to claim 5, wherein the steering mechanism steers only the second axle.
